(19) United States
(12) Patent Application Publication
(10) Pub. No.: US 2008/0131861 A1
(43) Pub. Date: Jun. 5, 2008

(54) SECURITY METHODS FOR PREVENTING ACCESS TO EDUCATIONAL INFORMATION BY THIRD PARTIES

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,322

(22) Filed: Sep. 6, 2007

Related U.S. Application Data
(60) Provisional application No. 60/824,750, filed on Sep. 6, 2006.
(60) Provisional application No. 60/945,872, filed on Jun. 22, 2007.

(51) Int. Cl. G09B 7/00; G09C 1/00

(52) U.S. Cl. 434/362; 726/5

(57) ABSTRACT

In a computing environment having an educational management system comprising a server, a method for distributing the educational information includes creating educational content at the computing device using an educational program, encrypting the educational content to form encrypted educational content and at least one key for decrypting the encrypted educational content, allowing a user to connect the computing device to the educational management system server through a network connection, transferring the encrypted educational content from the computing device to the educational management system, and transferring the key from the computing device to the educational management system. The educational programs are capable of creating educational content on the computing device while not connected to the network.

### CROSS-REFERENCE TO RELATED APPLICATIONS

This application claims priority to Provisional Application Ser. No. 60/824,750, filed Sep. 6, 2006 and Provisional Application Ser. No. 60/945,872, filed Jun. 22, 2007, which applications are incorporated herein by specific reference.

### BACKGROUND OF THE INVENTION

1. The Field of the Invention

The invention generally relates to online systems for educational course materials, and more particularly to systems for preventing access to SCRM information by third parties.

2. The Relevant Technology

Web-based learning management systems (LMS) and content management systems (CMS) have been increasingly used by corporations, government agencies, and higher education institutions as effective and efficient learning tools. An LMS is a software package that facilitates the management and delivery of online content to learners, often in order to enable the individualized and flexible access to learning content. Typically, an LMS allows for an online teaching environment, where a CMS is a computer software system that is typically used to manage the storing, controlling, versioning, and publishing of the educational content. Using a combination of the above technologies, several educational systems have been developed in the art that offer flexible online learning solutions for educators.

Due to the flexible and individualized nature of the systems, users and employees can take courses on their own time and at their own pace, in accordance with their various daily commitments, while educators, management, and human resource departments are able to track progress. Further, because the systems may be easily updated and modified, the systems often provide more relevant information than is currently available using traditional teaching tools.

One advantage of these courses is the ability to give users key information they need outside the confines of the traditional university buildings or classrooms. The distance learning users can gain access to the course materials by connecting to the Internet or other global network. Thus, several institutions have implemented online or hybrid courses where the course is administered wholly or partially in the online setting.

Despite these advantages, however, these systems present problems when educators or users may be relatively difficult to secure. In particular, distributing content in a secure manner may often require the use of secure channels, which may be slower or less convenient to use than ordinary channels.

### BRIEF SUMMARY OF THE INVENTION

In a computing environment including an educational management system comprising a method is provided for providing educational information. In one aspect of the invention, the method includes creating educational content at the computing device using an educational program, encrypting the educational content to form encrypted educational content and at least one key for decrypting the encrypted educational content, allowing a user to connect the computing device to the educational management system server through a network connection, transferring the encrypted educational content from the computing device to the educational management system, and transferring the key from the computing device to the educational management system. The educational programs are capable of creating educational content on the computing device while not connected to the network.

In another aspect, a system for creating a customized curriculum for a user in a computing environment for online courses includes a content provider for providing educational content to be accessed by a user's computer. The content provider may be configured to encrypt the educational content to form encrypted educational content and at least one key. The system also includes an educational management system including a server and a database, wherein the content provider is configured to send the educational content to the educational management system over a first network channel and to send the at least one key to the educational management system over a second channel on a second network channel, the second network channel being a secure channel.

These and other aspects of the present invention along with additional features and advantages will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-B are block diagrams illustrating a learning system platform which provides for the creation of educational content by a content provider and transmission of the educational content according to one example;

FIG. 2 is a flowchart illustrating a method of creating and distributing online content according to one example;

FIG. 3 is a schematic diagram of the application of encryption to educational content according to one example; and

FIG. 4 is a flowchart illustrating a method of creating and distributing online educational content according to one example.

### DETAILED DESCRIPTION OF THE VARIOUS EMBODIMENTS

Systems and methods are provided herein for creating and distributing educational content. The educational content may include course materials for use in online or other distributed courses. In one example, a learning system platform includes an educational management system. Content providers provide educational content to the educational management system. The educational management system then distributes the educational content to the intended users. As used herein, the term “user” may be used to describe users, employees, content providers, educators, employers, or course administrators who are accessing the education management system using a computer. The computer may be any specific of general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the education management system using the same computer.

The presents system and methods may allow content providers to create educational content using a computing device regardless of whether the computing device is connected to the educational management system. In one example, the content providers create educational content which is sharable content object reference model (SCORM) compliant, such as educational programs with SCORM editor interfaces. The educational content may be created as course materials for one or more online course. Each online course may further include several course objectives. Each course objective may represent some portion of the educational content which a user must pass in order to finish the course. The educational content created by the content provider may include all of the course objectives.

The educational content can be encrypted before the educational management system distributes the educational content to the intended users. In one example, the educational content is compressed and encrypted on the content provider's computing device before the educational content is sent to the educational management system. The computing device can also be configured to generate one or more keys for decrypting the educational content. Specifically, one method for encrypting the educational content includes packing the educational content into a cryptographic envelope, also referred to as a cryptolope. Further, the educational content may be encrypted using a format based on standards reviewed by experts in the field, such as through the use of XML standard to provide metadata, encryption, and signatures. The educational content may include any number of smaller parts, such as course material related to course objectives or to portions of the course objectives. The educational content may be compressed using standard data compression, such as through the of the .ZIP file format to combine multiple file streams associated with the smaller parts in the educational content into a single file.

The course objectives, as well as a valuation system and assessment that may reside on the educational management system, may be created as part of the educational content, or may be created elsewhere. The principles of the various embodiments are described using the structure and operation of examples. The various examples provide the capability to generate secured content which may then be presented to users.

In some examples, the distributed nature of the system 10 may allow the various users to utilize aspects of the educational system while offline, meaning that the users may continue working regardless of their present interconnectivity. As discussed more specifically below, the system operates by distributing various learning software onto the user computer when the user is connected to the system, wherein the learning software continues being used when the user is no longer connected to the system. Later, when the user connects to the system, the user's computer and the educational system perform a syncing operation. During the syncing operation, the educational system receives any work or new data that has been created or modified while the user's computer was offline and the user's computer receives any new information or data available on the educational system.

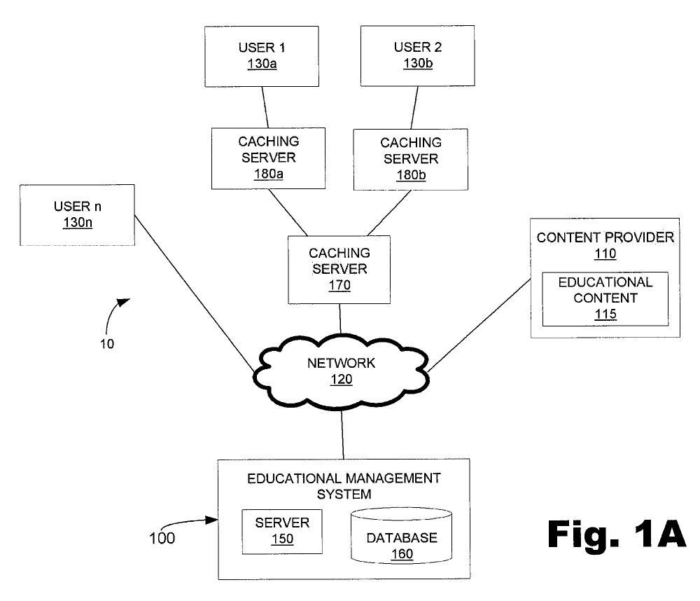

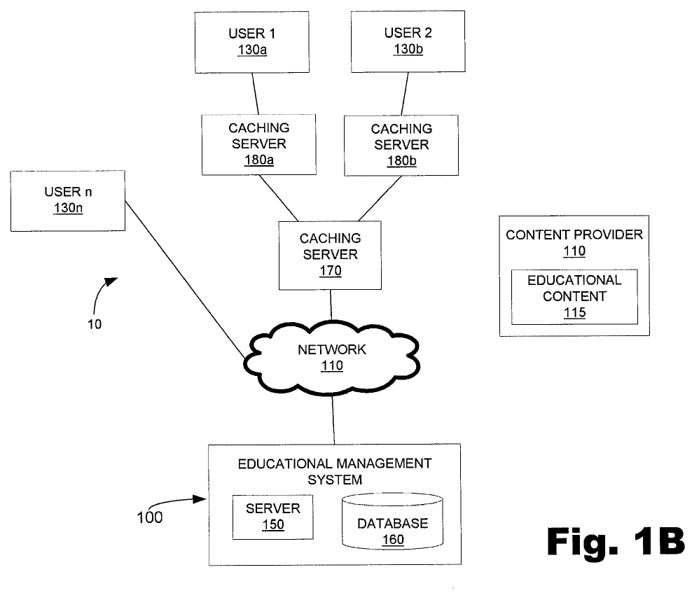

FIG. 1A is a block diagram of a distributed learning platform system 10 that includes an educational management system 100 according to one example. The educational management system 100 allows a content provider 110 to create educational content 115, to secure the educational content 115, and to convey the secured educational content over a network 120 to a number of users, “User 1” 130a through “User n” 130n, who are connected to the educational management system 100. The connection of the users 130a-n to the network will be discussed in more detail below. As will be understood by one of ordinary skill in the art, the network 120 may be any local or global network, including a LAN, WAN, wireless network, internet connection, and the like.

In one embodiment of the invention, the education management system 100 includes a server 150 capable of sending and receiving communications and data via the network 120, along with a database 160 capable of storing a plurality of educational software, programs, and data. In addition, the database 160 can be used to store data relating to the user identification. As will be understood by one ordinarily skilled in the art, any number of configurations may be used to create an education system, including systems using a series of interconnected databases, computers, and servers.

In this example, the education management system 100 is connected to a content provider 110. Here, the content provider 110 may be an instructor who is responsible for creating course software. In contrast, the content provider 110 may be part of the education management system 100. Further, the content provider 110 may be a third party or course developer who connects to the education management system 100 as a user.

The distributed learning platform system 10 may include caching servers 170, 180a-b. In the illustrated example, caching server 170 may be configured to receive encrypted educational content from the educational management system 100, such as over the network 120. The caching server 170 may then distribute the encrypted educational content to additional caching servers, such as caching servers 180a-n. Similarly, caching servers 180a-b may be configured to be synched with educational information associated with users 130a-b and/ or content provider 110. The synched educational information may then be uploaded to caching server 170 and then to the educational management system 100. As illustrated in FIG. 1A, users, such as user 130n, may communicate with the educational management system 100 over the network 120 without intervening caching servers. Accordingly, various configurations may be utilized to transfer information between the users 130a-n and the educational management system.

One example of educational content may specifically include educational content which is created by a content provider 110. The educational content is secured, such as through an encryption process. In particular, the educational content may be encrypted by generating encrypted educational content and keys for decrypting the encrypted educational content. In one example, the educational content may be encrypted at the content provider 110 and then sent to the educational management system 100. The keys may be used to decrypt the encryption and when recombined with the encrypted educational content provides educational content 115. The keys may be sent over a second channel. The educational management system 100 may then store the encrypted educational content 115 and the associated key on the database 160.

In another example, the unencrypted educational content may be sent over a secure channel to the educational management system 100. After receiving the unencrypted educational content from the content provider 110, the educational management system 100 may then secure the educational content, such as through an encryption process which creates encrypted educational content and associated keys, and stores both on the database 160.

In either case, the educational management system 100 may then distribute the educational content. In one example, the educational management system 100 begins distribution of the educational content by sending the encrypted educational content to caching server 170, which may in turn distribute the encrypted educational content to other caching servers, such as caching servers 180a-b, as previously introduced. While one configuration is illustrated, any number of caching servers may be utilized, including any number of levels of caching servers, to provide access to the educational content from distributed sources to the users 130a-n.

The use of the caching servers 170, 180a-b may allow the educational management system 100 to distribute the content in an efficient manner. In particular, users 130a-n may access the caching servers 180a-b as primary access points, rather than accessing the educational management server 150 directly. The caching server 170 may communicate with the educational management server 150 when bandwidth is available, thereby decreasing congestion which would be associated with each user contacting the educational management server 150 directly. Accordingly, educational content may be sent and received by the caching servers 180a-b over a period of time. Such a method of distribution may be capable of distributing large amounts of data widely without requiring the content provider 110 or server 150 to incur the large costs of hardware, hosting, and bandwidth resources that would otherwise be required to distribute the educational content.

Further, such a configuration may allow the “trickling” of educational content, meaning that in situations where the content to be sent is a large file, the system may transmit smaller discrete portions of the content, instead of requiring a constant connection for the duration of the transmission process. A scheduled transmission can populate the caching servers with course content over a controlled distribution. The same process may be used for communication between users 130a-n and the educational management system 100.

Thus, in situations where a large number files need to be distributed to a number of caching servers, such as at the beginning of a semester or session, when each caching server requires the content associated with the course, the educational content 115 may be effectively distributed without overwhelming the education management system 100. In the illustrated example, multiple caching servers 170, 180a-b are illustrated. More or less caching servers may also be utilized.

The educational content stored on the caching servers 180a-b may be accessible to any number of users. The encryption applied to the encrypted educational content may allow administrators to reduce the unauthorized, undesired, and/or unintended use of the educational content by parties whom administrators and/or the content provider wish to prevent from using the encrypted educational content. In particular, while any user may be able to download the encrypted educational content from the caching servers 180a-b, in its encrypted format, the encrypted educational content may display as a useless combination of characters.

Accordingly, a key is provided to intended users 130a-n to allow the users to use the encrypted educational content. As previously introduced, the key may be provided with educational content which is sent to the educational management system 100 and then subsequently sent on from the educational management system 100. A key may also be generated by the educational management system 100 and sent to the user. Further, a key may also be sent from the content provider 110 directly to the users 130a-n. Secure and non-secure channels may be used for communication between the content provider 110, the educational management system 100, and the users 130a-n.

The encrypted educational content that is conveyed and stored on the caching servers 170, 180a-b may be stored on the caching servers 170, 180a-b in an encrypted format. Encrypting the educational content 115 to form the encrypted educational content and key may allow the learning platform system 10 to send and store the encrypted educational content without additional security means, such as the use of a secure channel and/or secured caching servers. In particular, in the event that an outside party accesses the encrypted educational content, the encryption may discourage that party from further attempting to use the educational content.

The educational management system 100 may be configured to provide the educational content 115 to the users 130a-n. In one example, multiple keys may be generated which correspond to different parts of the encrypted educational content. Such a configuration may allow the educational management system 100 to send different keys to different users 130a-n. Sending different keys to different users may allow the distributed learning platform system 10 to provide access to different portions of the educational content 115 to different users, based on any number of factors or criteria. This in turn may allow for the creation and convenient distribution of personalized curriculum.

FIG. 1B illustrates the ability the content provider 110 or a user 130a-n to interact with educational content where a user, here the content provider 110, is no longer connected to the education management system 100 via the network 120. As described more fully below, one advantage of the present invention is its ability to transfer or distribute software and/or data from the content provider 110 to the educational management system 100 while continuing to create educational content when the computer is not connected to the management system 100. When content provider 110 later establishes a connection with the educational management system 100, such as the connection shown in FIG. 1A, the system 100 will perform a syncing operation, wherein it will send and receive data from the content provider 110 until both the system 100 and the content provider 110 have updated information. This information may include educational content 115 which the content provider 110 that has worked on or completed while the content provider 110 is disconnected from the network 120.

The system has the ability to send to and receive content from the educational management system 100. Supported content includes SCORM courses, course documents, discussion threads, and other asynchronous collaboration, assignments, grade book, usage status, and assessments. The system supports “round tripping” enabling content to be download or uploaded as necessary. Automatic or manual synchronization, whenever a network connection is available, is supported to keep content current and up-to-date. The course information can be bidirectional and sequential synchronized. This synchronization or “roundtripping” feature updates assignments and assessments. Users can download assignments and assessments to work on them in an environment that is disconnected from the network. The user can also upload results when a connection to the CMS/LMS is established. Furthermore, a user can also download instructor's comments and grades, and resubmit assignments.

The system can also support course development programs, such as an authoring client software product which enables an author to create educational content. Such programs can enable learning unit authoring, exam editing, HTML editing, rich media support, document attachment, support for ZIP files, and grade book and assignment creators. The program may also provide the author the ability to review the course and the ability to later publish it to the educational management service, during a sync or similar operation.

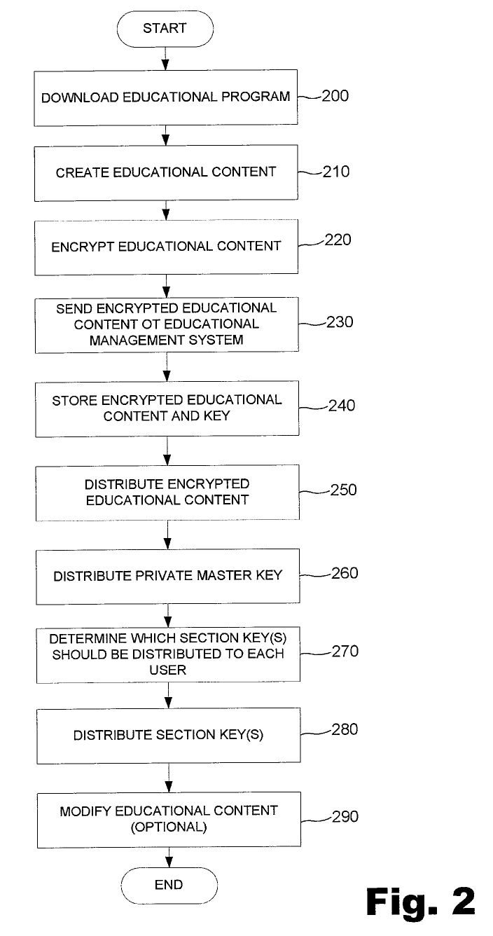

FIG. 2 is a flowchart illustrating a method of creating and distributing educational content according to one example. The method may optionally begin at step 200 when a user downloads educational programs for creating educational content. In one example, the educational programs may be distributed from one or more caching server to the content provider. Further, the present method may allow users to work on creating educational content regardless of their ability to connect to a caching server and/or to the educational management system.

Accordingly, while the user is working offline, the system retains the ability to perform computing functions often performed while the computing device is connected to the educational management system. For instance, educators and course administrators are able to create or combine new course material, respond to bulletin board messages, and/or grade assignments or tests while offline. In some cases, the educational program may already be residing on a content provider's machine, and thus downloading the educational program may optionally be omitted.

In either case, the method continues by creating educational content at step 210, such as through the use of the educational programs discussed above. The educational content may include course material. The course material may be divided into any number of portions. These portions may correspond to course objectives, which may either be created by the content provider, by the educational management system, or elsewhere. As will be discussed in more detail below, dividing the course material into several portions may allow the system to create a personalized curriculum. For example, the personalized curriculum may be based on an assessment of a user's mastery relative to a certain portion of the online course. In particular, the system may be configured to test the ability of user to display mastery of the course objectives using a user assessment.

Any educational program may be used in creating the educational content. Some examples include, without limitation, educational programs that include a Sharable Content Object Reference Model (SCORM) editor, or other software that can be coupled to the educational distribution system. For ease of reference, a SCORM editor will be discussed below.

SCORM refers to a set of protocols and standards by which educational content that enable interoperability, accessibility, and reusability of educational content between content providers and users. In general, a SCORM editor helps ensure that the educational content can be delivered via a web-browser, that the content does not rely on server side scripting languages or external files or uniform resource locators, and that the information may be downloaded and installed by the user, rather than by an administrator.

In order to help provide such conformance, the SCORM editor organizes the content files into a single directory structure, defines and describes the educational content using a predetermined file type, such as an XML manifest file; and packages the educational content and associated files for running the educational content into a ZIP file. The use of a SCORM editor allows the content to be properly formatted as the educational content is created. Such an approach may increase the correlation between what a content provider sees while creating educational content and what users or other users will see when such users access the educational content. Such correspondence may be increased by providing a what-you-see-is-what-you-get (WYSIWYG) interface. While a SCORM editor is described, the content may be created using different interfaces, including an interface which applies the available SCORM protocol to the educational content after the educational content has been created.

In either case, after the educational content has been created and/or has been formatted for SCORM protocol conformance, at step 220 the educational content is then encrypted. In one example, the educational content may be placed within a container, such as .ZIP file and packaged in a cryptographic envelope, also called a “cryptolope.”

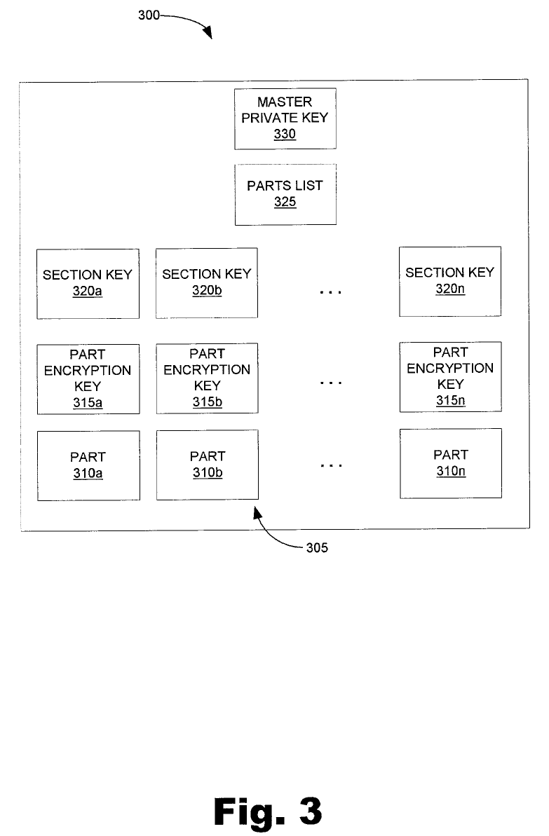

FIG. 3 is a schematic diagram of a cryptolope 300 according to one example. The cryptolope 300 secures content 305 through the use of multiple layers of encryption. This content may specifically include educational content that complies with the SCORM protocol may include various sharable content objects, a package interchange file, metadata, resources, sequence and navigation rules, and/or other components. The educational content may include course materials for an online or other distributed course, which may be divided into any number of parts. These parts may include course material intended for use by one or more users.

When the educational content is packed into the cryptolope, educational content may be assembled from any number of parts 310a-n. Part encryption keys 315a-n are then generated, each of which are used to encrypt a corresponding part 310a-n of the educational content 305. The part encryption keys 315a-n may be generated to correspond with course material for each course objective. Further, the part encryption keys 315a-n may be random advanced encryption standard (AES) keys.

The part encryption keys 315a-n are then further encrypted using a master key 330. In one example, different encryption keys 310a-n may be encrypted additional section keys 320a-n as well as the master key 330. In particular, separate section keys 320a-n may be used to encrypt selected parts 310a-n, which may include the course material associated with each of the course objectives the addition of section keys allows access to the parts to be individually controlled while the master key continues to govern overall access. Accordingly, encryption is used to secure the educational content. In addition to encrypting the parts, a parts list 325 is created. The parts list 325 may then be encrypted using a private master key 330. The master key 330 provides a key for decrypting the list. In another example, some of the educational content may be placed within the .ZIP container that remain unecrypted. In one example, the master key is a public key for which the user possesses the matching private key.

Returning to FIG. 2, once the desired parts of the educational content has been secured, such as by packing the educational content into a cryptolope to form encrypted educational content, the educational content may then be sent to an educational management system at step 230. As previously discussed, the encrypted educational content may be sent over an unsecured channel. Sending encrypted educational content over unsecured channels may increase the ease and/or speed of transmitting educational content from content providers to the educational management system.

If the encrypted educational content is sent over the network on an unsecured channel, it may be possible for unintended parties to receive the encrypted educational content. However, as previously discussed, the security measures applied to the educational content may reduce the possibilities that an intercepting party will be able to use the educational content without the private master key as well as the section key or keys for each of the parts. In one example, the master key may be sent separately over a secure channel. The section keys may also be sent over a secure channel. The secure channel may be different than the unsecured channel. Or the master key and the section keys may be encrypted using a public key for which the user possesses the private key. In this case, the encrypted keys could be sent over the same open channel as the content.

In other examples, it may be desirable to maximize the security associated with sending the educational content from the content provider to the educational management system. In such cases, it may be desirable to send both the master key and the encrypted educational content over a secure channel as well. The secure channel used to send the encrypted educational content may or may not be the same secure channel by which the master key is sent. The use of the redundant security measures of a secure channel and encrypted educational content packed in a cryptolope may increase the security associated with transmitting educational content.

Once the encrypted educational content and the master key and section keys are received by the educational management system, at step 240 the educational management system stores the combined encrypted educational content and keys. Storing the encrypted educational content and the keys also includes noting the relationship between the keys as well as any other information useful for retrieving both the encrypted educational content and the keys. One approach is to assign a unique identifier to each key. In this case the encrypted content would include the identifier of the required key. The keys themselves would be stored in a separate, secure database and indexed according to their identifiers.

Once the educational content, which may include the encrypted educational content and associated keys, is stored on the educational management system at step 250, the encrypted educational content may be distributed. In one example, the encrypted educational content may be sent to caching servers as described above with reference to FIG. 1. Further, in some examples, the encrypted educational content may be sent to caching servers over an unsecured network. Once the caching servers receive the cryptolopes, in one example the caching servers store the encrypted educational content without applying additional security measures.

At step 260, the educational management system may then distribute the master key. The master key may be distributed to each member of a selected group, such as a class, a discussion group, or selected group. In one example, the master key may be distributed as a password. The password may be distributed by a teacher or other user at a remote location to allow distributed users to access the educational content. The master key allows users to access open the encrypted educational content by allowing access to the parts list. However, the content within the encrypted educational content, such as each of the parts discussed above is encrypted with a part encryption key, which may also be secured by a corresponding section key.

At step 270, the education management system then determines which section key or keys to make available to each user. The distribution of the section keys may allow the educational management system to selectively grant access to portions of the content to specific users. In one example, determining which section key or keys to make available to a user may include administering a user assessment.

Determining which section key or keys to make available may include creating or adopting one or more user assessments, creating or adopting course objectives, and establishing criteria for determining whether results of the user assessment indicate that a user has displayed a mastery of one or more of the course objectives. While the step of creating educational content has been described above with reference to creating a user assessment as well as criteria for determining whether course objectives have been met, the user assessment and criteria may be generated at the educational management system or any other location. As will be discussed in more detail below, the user assessment may be used to generate a personalized curriculum for each user which includes selected additional course material.

The user assessment may be created as part of the step of creating educational content, established by the educational management system, or may be adapted from existing educational content. In either case, selected questions in the assessment may correspond to different course objectives. Criteria may be established for performance on the user assessment for the selected questions corresponding to each course objective. For example, in order to show mastery of a course objective, criteria may be established which requires a user to answer a certain number of questions of correctly.

In such an example, when a user answers enough questions correctly for a course objective, the system may determine that the user has showed mastery of that course objective. If the user does not answer enough questions correctly or otherwise demonstrate mastery of the course objective, additional course material related to the course objective may then be flagged for delivery to the user. In the course creation step, additional course material for each of the course objectives may be provided as well as the criteria for using the user assessment to determine whether a user has shown mastery of the course objectives.

In one example, the section keys may be used to create personalized curriculum for users. In particular, the section keys which are made available to a user, such as a student, may depend on the user's performance on the user assessment. In particular, if a user demonstrates passes course objective as measured by the user assessment, the section key associated with the mastered course objected may not be selected for that particular user. Similarly, if the user assessment indicates that the user has not shown a mastery of the course objective, a section key for the course material may be selected.

Once the system has determined which section keys are to be delivered to each user, at step 280 the section keys are distributed. The section keys may be sent over a secure channel to each of the users or they might be encrypted using a public key for which the user has the corresponding private key. Consequently, the section keys may be used to provide personalized curriculum from a larger volume of educational content for each user. Accordingly, one embodiment of the method allows a content provider to create educational content, such as course material, regardless of the availability of a network connection.

At some point, it may be desirable for the content provider to modify the educational content as indicated at step 290. In one example, the educational content may be removed from the caching servers and sent from the educational management system back to the content provider. The educational content may be sent back to the content provider in a similar manner by which the content provider sent the educational content to the educational management system or in another manner known by one ordinarily skilled in the art to transfer content. The content provider may then decrypt the educational content and revise or modify the educational content as desired. The content provider may then encrypt the educational content and send the educational content to the educational management system for distribution, as previously discussed.

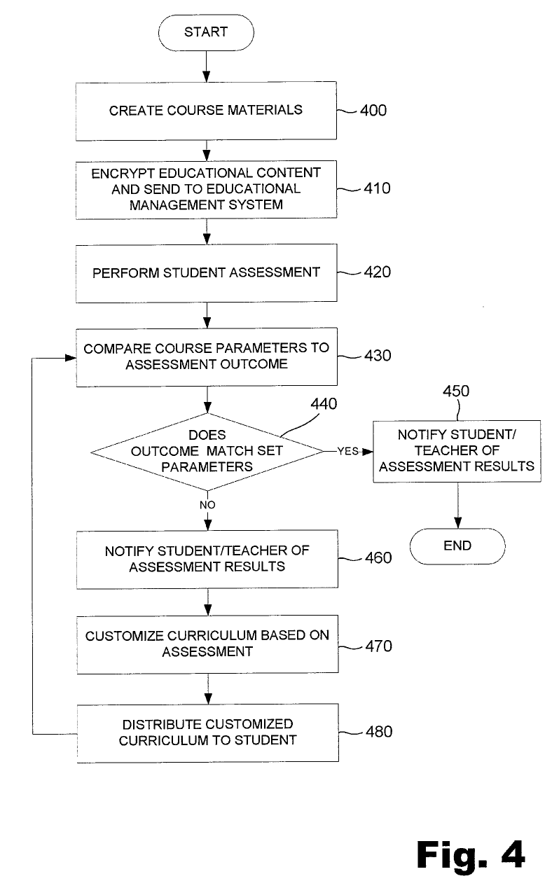

FIG. 4 is a flowchart illustrating one method of using educational content that has been encrypted. The educational content may be stored on caching servers or other locations which are accessible to the users. At step 400, course materials for various course objectives are created for a particular course by a content provider. Step 400 may be similar to step 210 discussed above with reference to FIG. 2. The course objectives are assigned values, such as numbers 0 through 100, letters, pass/fail, topic expressions, and the like, to be compared to the user's assessed performance. Parameters are set for course objectives. A parameter, for instance, can be selected based on an exemplary user's performance on an assessment test, meaning that the parameter will be deemed to be the performance of a typical user who has sufficiently mastered a particular course objective. Thus, the parameter may be used to determine whether a student has passed a particular course objective by comparing the student's assessment performance with the parameter.

The parameter may include a Boolean expression, such as >, <, =, not, or any combination thereof. By way of an example, an educator may determine that any user who receives a score of >=80 percent on all questions relating to a particular objective on an assessment test has demonstrated an adequate mastery of the objective. Thus, if the user receives a score higher than 80 percent, then the user will be deemed to have passed the learning objective.

The course objective may be assigned values and the parameters may be set for the course objectives either at the content provider's computing device or at the educational management system. In either case, at step 410 the educational content is encrypted and sent to the educational management system, along with the keys for decrypting the educational content, as described above with reference to FIG. 2.

At step 420, the system administers a user assessment. The user assessment may be a test, quiz, or similar evaluation mechanism that measures the user's understanding and mastery of a particular course objective or group of course objectives. The user's performance may be measured, for example, in the number of correct answers, letter grade, percentage, pass/fail expression or other methods typically used in the educational system and can be weighted to meet a specific course emphasis for the course. As may be understood by one of ordinary skill in the art, a single assessment test may be used to determine a user's knowledge of a plurality of learning objectives for a particular course or series of courses.

The user's performance may be stored in the system, and at step 430, the user's performance or assessment outcome is compared to course parameters to provide comparison data. The comparison data can be stored in memory, such as in the database or on the server of the educational management system. If the outcome meets the set parameters discussed above, then at step 440, the user is deemed to already know the course objectives for the course. At step 450, the system notifies the teacher, the user, or parent that the user already has a mastery of the learning objectives, and the process ends without the system creating any curriculum for the user.

If at step 440, it is determined that the outcome of the user's assessment is below or does not match the set parameters, then at step 460, the system notifies the teacher, user, or parent of the results of the assessment outcome. Using this feedback mechanism, the system is able to notify the user, teacher, and parent of the areas that the student has and has not passed. Advantageously, this allows the teacher and parent to identify the areas that the user needs additional help, and alerts the user to the areas that need the most work. At step 470 the system creates a personalized curriculum for the user based on the outcome. Examples of methods of developing the personalized curriculum will be discussed more fully below.

At step 480, the system distributes the customized curriculum and the process continues from step 420. In particular, the course materials, which include all of the course objectives, may be stored on a caching server in an encrypted format. In order to distribute the materials, the system may distribute a section key to the user corresponding with the course objective which the user did not master.

Using this system, the system continues to generate customized content for the user until the user demonstrates a sufficient mastery of the subject. Advantageously, this allows users to continue to work on a topic until they have fully grasped the concepts, rather than forcing them to move on to the next topic simply because the majority of their classmates are ready to do so.

The present method also provides for the encryption of the educational content by which encrypted educational content may be sent to the server and the keys for decrypting the educational content may be sent separately, as desired. The encrypted educational content may then be distributed and stored to users as desired. The distribution of the keys may then be controlled to help ensure that the users which use the educational content are the intended uses. Further, distribution of section keys may be controlled to personalize curriculum for individual users. Secure channels may be used to send the encrypted educational content throughout the process as desired, such as to increase the security of the educational content.

Additional methods may include creating the education content as described above and then sending the educational content without encrypting the educational content to the educational management system. The educational content may be sent over a secure channel or an unsecured channel as desired. Once the educational content is received by the educational management system, the educational management system may then encrypt the educational content as described above and distribute the section and master keys to the intended users as desired.

Embodiments of the present invention may include or be conducted using a special purpose or general-purpose computer, processor, or logic device including various computer hardware and devices, as discussed in greater detail herein or known to one ordinarily skilled in the art. Embodiments within the scope of the present invention can also include computer-readable media for carrying or having computer-executable instructions or data structures stored thereon. Such computer-readable media can be any available media that can be accessed by a general purpose computer, special purpose computer, or a logic device. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose computer, special purpose computer, or other logic devices.

When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Various combinations of the above should also be included within the scope of computer-readable media. Computer-executable instructions comprise, for example, instructions, logic, and data which cause a general purpose computer, special purpose computer, or logic device to perform a certain function or group of functions.

Each of the processors described herein can be a single conventional general purpose computer, special purpose computer, or logic device, or each processor can be multiple processors including multiple conventional general purpose computer, special purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the present invention. For example, additional processors may be implemented for storage and retrieval of data as is known to one of ordinary skill in the art. Such details have been eliminated so as to not obscure the invention by detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment having an educational management system including a server, a method for distributing educational information, the method comprising:
creating educational content with a computing device using an educational program;
encrypting the educational content to form encrypted educational content and at least one key for decrypting the encrypted educational content;
connecting the computing device to the educational management system server through a network connection;
transferring the encrypted educational content from the computing device to the educational management system, and
transferring the key from the computing device to the educational management system,
wherein the educational program is capable of creating educational content on the computing device while not connected to the network.

2. The method of claim 1, wherein the step of encrypting the educational content includes packing the educational content into a cryptolope.

3. The method of claim 1, wherein the step of encrypting the educational content is performed on the computing device.

4. The method of claim 1, wherein the step of transferring the encrypted educational content includes transferring the encrypted educational content over the network on an unsecured channel.

5. The method of claim 1, wherein the step of transferring the at least one key includes transferring the key over the network on a secure channel.

6. The method of claim 1, further comprising a step of distributing the encrypted educational content and the key.

7. The method of claim 6, wherein the step of distributing the encrypted educational content includes storing the encrypted educational content on at least one caching server.

8. The method of claim 1, wherein the step of creating the educational content includes creating course objectives that correlate with course materials for an online course and wherein the step of encrypting the educational content includes generating a plurality of section keys and encrypting the course objectives with the section keys.

9. The method of claim 8, wherein the step of creating course objectives includes assigning a value to the course objectives, and further including the steps of setting a parameter for the course objectives and associating the parameter with the value, performing an assessment evaluation of a user, the assessment evaluation correlating to the course objectives of the online course; tracking the outcome of a user's performance on the assessment evaluation; comparing the outcome to the course objectives to provide comparison data, the comparison data being stored on the educational management system; creating a customized curriculum for the user based on the comparison data, the customized curriculum comprised of course materials; and distributing a section key to the user corresponding to the course materials within the customized curriculum.

10. The method of claim 1, wherein the step of setting a parameter includes setting a parameter that is stored on the educational management system.

11. The method of claim 1, wherein the step of creating the educational content includes creating sharable content object reference model (SCORM) conformant educational content.

12. The method of claim 1, wherein the step of transferring the at least one key includes encrypting the key using a public key for which the intended recipient has the corresponding private key and transferring the encrypted key over the network on an open channel.

13. A system for creating a customized curriculum for a user in a computing environment for online courses, the system comprising:
a content provider for educational content to be accessed by a user's computer, the content provider being configured to encrypt the educational content to form encrypted educational content and at least one key associated with encryption; and
an educational management system including a server and a database, wherein the content provider is configured to send the educational content to the educational management system over a first network channel and to send the at least one key to the educational management system over a second channel on a second network channel, the second network channel being a secure channel.

14. The system of claim 13, wherein the content provider encrypts the educational content by packing the educational content into a cryptolope.

15. The system of claim 13, wherein the educational management system is configured to distribute the course materials from the content provider to the user's computer.

16. The system of claim 15, further comprising at least one caching server, wherein the caching server distributes the educational content by storing the encrypted educational content on the caching server and distributing the at least one key to the users.

17. The system of claim 13, wherein content provider is configured to create educational content that includes course materials corresponding to course objectives.

18. The system of claim 17, wherein the educational management system is configured assign a value to the course objectives, the educational management system being configured to associate data with the course materials and correlate course objectives with the course materials, the educational management system including parameters set for the course objectives and associated with the value, wherein the information transferred between the educational management system and the user's computer is associated with a particular online course and user in the database, the outcome of a user's performance on an assessment is stored on the server, the outcome includes a grade associated with the user, the outcome is compared to the course objectives to provide comparison data stored on the server, and the comparison data is used to generate a customized curriculum for a user comprised of course materials.

19. In a computing environment for online courses, a method for creating a customized curriculum for a user, the method comprising:
creating a plurality of course objectives for an online course, the plurality of course objectives including a value stored on an educational management system;
setting a parameter for each of the plurality of course objectives and associating each parameter with a value, the parameters being stored on the educational management system;
creating course materials which correlate to the course objectives, the course materials being creating on a content provider's computing device;
encrypting the course materials to form encrypted course materials and a plurality of keys;
sending the encrypted course materials to the educational management system over a first network channel;
sending the key to the educational management to the educational management system over a second network channel, the second network channel being a secured network channel;
performing an assessment evaluation of a user, the assessment evaluation including data correlating to each of the course objectives of the online course;
tracking the outcome of a user's performance on the assessment evaluation;
comparing the outcome to each of the course objectives to provide comparison data, the comparison data being stored on the educational management system;
creating a customized curriculum for the user based on the comparison data for each of the course objectives, the customized curriculum comprised of course materials which correlate with course objectives, wherein creating customized curriculum includes selecting at least one selected key from the plurality of keys; and
distributing the course materials from the educational management system to a user's computer through a network connection, wherein distributing the course materials includes distributing the selected key.

20. The method of claim 19, wherein the step of creating course objectives includes assigning values to define an expected score for a user with an acceptable mastery of the course objective.

21. The method of claim 20, wherein assessment evaluation of the user comprises a course assignment, quiz, test, or project.

22. The method of claim 19, further comprising notifying the user of the of the comparison data.
